(19) United States
(12) Patent Application Publication
(10) Pub. No.: US 2024/0137875 A1
(43) Pub. Date: Apr. 25, 2024

(54) METHOD FOR ADJUSTING TIME-AVERAGED PARAMETERS OF TRANSMITTING POWER OF RADIO MODULE AND ASSOCIATED RADIO MODULE

(71) Applicant: MEDIATEK INC., Hsin-Chu (TW)

(72) Inventors: Yi-Ying Huang, Hsinchu City (TW); Yi-Hsuan Lin, Hsinchu City (TW); Han-Chun Chang, Hsinchu City (TW)

(73) Assignee: MEDIATEK INC., Hsin-Chu (TW)

(21) Appl. No.: 18/375,555

(22) Filed: Oct. 1, 2023

Related U.S. Application Data
(60) Provisional application No. 63/380,761, filed on Oct. 25, 2022.

(51) Int. Cl. H04W 52/36

(52) U.S. Cl. CPC H04W 52/367

(57) ABSTRACT

A method for adjusting time-averaged (TA) parameters of a transmitting (TX) power of a radio module includes: obtaining at least one message of the at least one other radio module or at least one message of the radio module; determining a scenario of the TX power of the radio module according to the at least one message of the at least one other radio module or the at least one message of the radio module; determining whether the scenario is different from a predetermined scenario of the TX power of the radio module; and in response to the scenario being different from the predetermined scenario, adjusting the TA parameters according to the scenario.

### CROSS REFERENCE TO RELATED APPLICATIONS

This application claims the benefit of U.S. Provisional Application No. 63/380,761, filed on Oct. 25, 2022. The content of the application is incorporated herein by reference.

### BACKGROUND

The present invention is related to radio frequency (RF) technology, and more particularly, to a method for adjusting time-averaged (TA) parameters of a transmitting (TX) power of a radio module and an associated radio module.

Nowadays, the RF technology has often appeared in a user equipment (UE; such as a mobile phone). However, excessive RF exposure may cause harm to human body. As a result, officials of different countries (e.g., federal communications commission (FCC) of USA, innovation, science, and economic development (ISED) of Canada, and conformite europeenne (CE) of Europe) regulate a TA RF exposure limit to limit a TA RF exposure of a radio module in the UE. For example, in response to a frequency band of the radio module being smaller than 6 GHz, the TA RF exposure will be quantified with a TA specific absorption rate (SAR). In response to the frequency band of the radio module being not smaller than 6 GHz, the TA RF exposure will be quantified with a TA power density (PD). In addition, since the TA RF exposure will be proportional to a TX power of the radio module, the TA RF exposure can meet the TA RF exposure limit by controlling the TX power.

In addition, TX power variation of the radio module is associated with TA parameter settings, wherein different TX power adjustment of the radio module will be required for different scenarios. For example, in response to a scenario requiring a low duty cycle and a high TX power, it is necessary to increase the TX power variation of the radio module. For another example, in response to a scenario requiring a stable TX power, it is necessary to decrease the TX power variation of the radio module. For an existing method, the TA parameter settings are predetermined and fixed. That is, a trade-off is required to be made among different scenarios to select a set of predetermined TA parameters suitable for all scenarios, which will result in poor performance. As a result, a novel method that can dynamically adjust TA parameters of a TX power of a radio module according to different scenarios and an associated radio module are urgently needed, to improve data throughput and network capacity efficiency.

### SUMMARY

It is therefore one of the objectives of the present invention to provide a method for adjusting TA parameters of a TX power of a radio module and an associated radio module, to address the above-mentioned issues.

According to an embodiment of the present invention, a method for adjusting TA parameters of a TX power of a radio module is provided. The method may comprise: obtaining at least one message of the at least one other radio module or at least one message of the radio module; determining a scenario of the TX power of the radio module according to the at least one message of the at least one other radio module or the at least one message of the radio module; determining whether the scenario is different from a predetermined scenario of the TX power of the radio module; and in response to the scenario being different from the predetermined scenario, adjusting the TA parameters according to the scenario.

According to an embodiment of the present invention, a radio module for adjusting TA parameters of a TX power of the radio module is provided. The radio module is arranged to: obtain at least one message of at least one other radio module or at least one message of the radio module; determine a scenario of the TX power of the radio module according to the at least one message of the at least one other radio module or the at least one message of the radio module; determine whether the scenario is different from a predetermined scenario of the TX power of the radio module; and in response to the scenario being different from the predetermined scenario, adjust the TA parameters according to the scenario.

One of the benefits of the present invention is that, by the method and the associated radio module of the present invention, under a condition that different TX power adjustment of a radio module are required for different scenarios, a scenario of a TX power of the radio module can be determined according to the at least one message of the radio module and/or at least one message of at least one other radio module, and the TA parameters for TX power variation of the radio module can be dynamically adjusted according to the determined scenario, which can improve data throughput and network capacity efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating interaction between two radio modules according to an embodiment of the present invention.

FIG. 2 is a diagram illustrating a TA parameter adjustment scheme according to a first embodiment of the present invention.

FIG. 3 is a diagram illustrating a TA parameter adjustment scheme according to a second embodiment of the present invention.

FIG. 4 is a diagram illustrating a TA parameter adjustment scheme according to a third embodiment of the present invention.

FIG. 5 is a diagram illustrating a TA parameter adjustment scheme according to a fourth embodiment of the present invention.

FIG. 6 is a diagram illustrating a TA parameter adjustment scheme according to a fifth embodiment of the present invention.

FIG. 7 is a diagram illustrating examples of a switching mode for multiple power levels of a TX power of a radio module according to an embodiment of the present invention.

FIG. 8 is a diagram illustrating a flow chart of a method for adjusting TA parameters of a TX power of a radio module according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

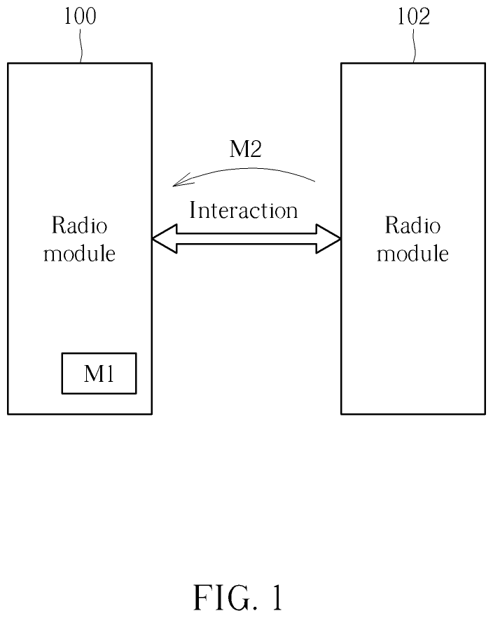

FIG. 1 is a diagram illustrating interaction between two radio modules 100 and 102 according to an embodiment of the present invention. By way of example, but not limitation, the radio modules 100 and 102 may include communication circuits corresponding to sub-6, millimeter wave (mmWave), Wi-Fi, BT, Zigbee, global positioning system (GPS), vehicle to everything (V2X), and non-terrestrial networks (NTN).

The radio module 100 may be arranged to receive a time-averaged (TA) RF exposure limit regulated by officials, wherein the TA RF exposure limit corresponds to the radio module 100. Since the TA RF exposure limit is proportional to a transmitting (TX) power of the radio module 100, the radio module 100 may be further arranged to map the TA RF exposure limit to a TX power limit TPL1 of the radio module 100. Specifically, the TA RF exposure limit may be a total exposure ratio (TER), wherein the TER may include a normalized average specific absorption rate (SAR) limit and a normalized average power density (PD) limit, and the TER is required to be less than or equal to 1 (i.e., TER 1). The radio module 100 may utilize a test or a simulation to find a first normalized average TX power limit mapped to the normalized average SAR limit and a second normalized average TX power limit mapped to the normalized average PD limit, wherein the TX power limit TPL1 includes the first normalized average TX power limit and the second normalized average TX power limit. However, this is for illustration only, and the present invention is not limited thereto. In some embodiments, the user may directly utilize the test or the simulation to find the TX power limit TPL1. That is, the TA RF exposure limit may also be mapped to the TX power limit TPL1 of the radio module 100 directly by the user.

It should be noted that the variation of a TA SAR and a TA PD is highly dependent upon TA parameters of a TX power of a radio module (e.g., the radio module 100), and the TX power of the radio module 100 can be adjusted by the TA parameters. For example, a TX power variation, the maximum instantaneous TX power, a range of a backoff TX power, a time window, and a number of power levels of the TX power of the radio module 100 can be increased/decreased by adjusting the TA parameters. In addition, the TX power of the radio module 100 may be in one of multiple scenarios SCE_1-SCE_N, and different scenarios prefer different TA parameter settings, wherein N is an integer greater than 1 (i.e., N>1). For example, under a condition that the TX power of the radio module 100 is in a scenario SCE_1 where a low duty cycle and a high TX power are required, the TX power variation of the radio module 100 may be required to be increased by adjusting the TA parameters. For another example, under a condition that the TX power of the radio module 100 is in a scenario SCE_2 where a stable TX power is required, the TX power variation of the radio module 100 may be required to be decreased by adjusting the TAparameters. It should be noted that the number of the scenarios SCE_1-SCE_N and the types of the scenarios SCE_1-SCE_N depend upon the actual design requirements, and the present invention is not limited thereto.

In order to determine which of the scenarios SCE_1-SCE_N the radio module 100 is in, the radio module 100 may obtain at least one message M2 of the radio module 102 and/or at least one message M1 of the radio module 100, and determine the scenario of the TX power of the radio module 100 according to the at least one message M1 and/or the at least one message M2, wherein the at least one message M2 is received from the radio module 102 by interacting with the radio module 102, and the at least one message M1 is calculated by the radio module 100. For example, the radio module 100 may determine the scenario of the TX power of the radio module 100 according to only the at least one message M2. For another example, the radio module 100 may determine the scenario of the TX power of the radio module 100 according to both the at least one message M1 and the at least one message M2. It should be noted that in some embodiments, under a condition that the radio module 100 is not able to receive the at least one message M2 from the radio module 102 due to some reasons, the radio module 100 may determine the scenario of the TX power of the radio module 100 according to only the at least one message M1. In some embodiments, after the radio module 100 receives the at least one message M2 from the radio module 102 by interacting with the radio module 102, the at least one message M2 may be stored in a memory (not shown in FIG. 1), and the radio module 100 may determine the scenario of the TX power of the radio module 100 according to only the at least one message M1. These alternative designs all fall within the scope of the present invention.

In this embodiment, the interaction for exchanging messages is performed between two radio modules (e.g., the radio modules 100 and 102). However, this is for illustrative purposes only, and is not meant to be as a limitation of the present invention. In some embodiments, the interaction can be performed between more than two radio modules. In practice, any radio module that is capable of interacting with at least one other radio module to receive at least one message M2, and determining the scenario according to the at least one message M1 and/or the at least one message M2, can be employed by the radio module 100.

The at least one message M1 and the at least one message M2 may include an on/off status of the radio module 100 and an on/off status of the radio module 102, respectively, wherein the off status represents that corresponding radio module has not performed a TX operation for a period of time (e.g., the corresponding radio module is in a shutdown mode, a flight mode, a sleep mode, a discontinuous transmission (DTX) mode, a call drop mode, or a no subscriber identity module (SIM) card mode), and the on status represents that the corresponding radio module is not in the off status. For example, when the corresponding radio module is not in the shutdown mode, the flight mode, the sleep mode, the DTX mode, the call drop mode, or the no SIM card mode, the corresponding radio module is in the on status. In addition, each of the at least one message M1 and the at least one message M2 may further include some information of the corresponding radio module. By way of example, but not limitation, the information of the corresponding radio module may include a previous TX power ratio, a TX power ratio margin, one or more TX performance indices, one or more receiving (RX) performance indices, one or more weighting information from a user, or one or more configurations.

The one or more TX performance indices may include at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER). The one or more RX performance indices may include at least one of a duty cycle of RX, a modulation and coding scheme (MCS), a block error rate (BLER), a resource block (RB), a received signal strength indication (RSSI), a reference signal receiving power (RSRP), a signal to noise ratio (SNR), a signal-to-interference-plus-noise ratio (SINR), and an RX packet error rate (RX PER). The one or more configurations may be related to at least one of an antenna, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, and a combination of the band and an SIM.

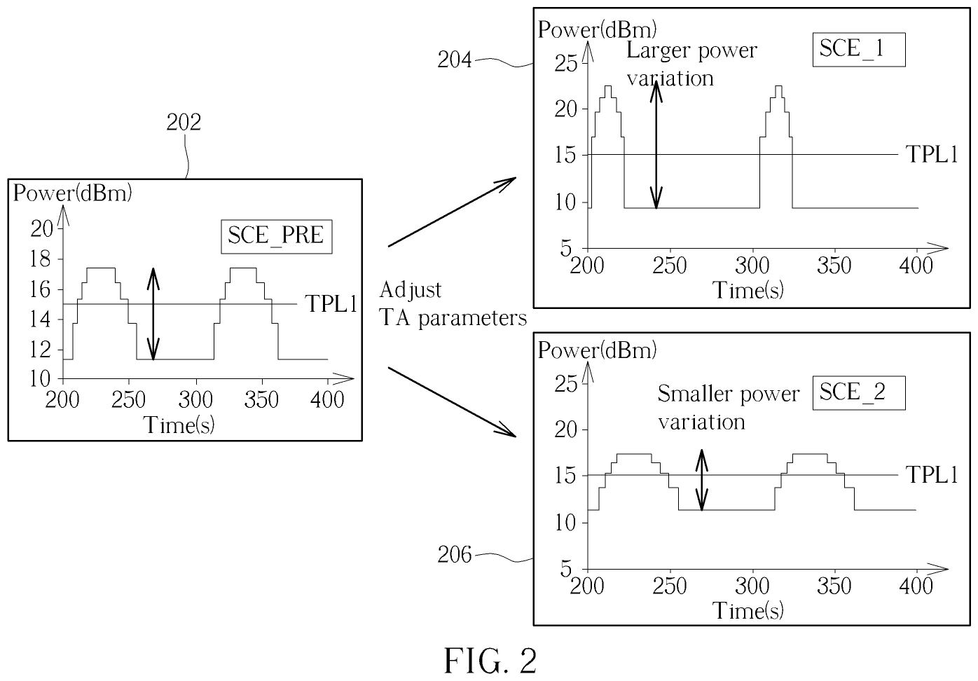

After the scenario of the TX power of the radio module 100 is determined, the radio module 100 may be further arranged to determine whether the determined scenario is different from a predetermined scenario SCE PRE of the TX power of the radio module 100, wherein in the predetermined scenario SCE PRE, the TX power of the radio module 100 is adjusted by a set of predetermined TA parameters. In response to the determined scenario being different from the predetermined scenario SCE PRE, the radio module 100 may dynamically adjust the TA parameters according to the determined scenario. Specifically, please refer to FIG. 2. FIG. 2 is a diagram illustrating a TA parameter adjustment scheme according to a first embodiment of the present invention. As shown in FIG. 2, three diagrams 202, 204, and 206 illustrate the TX power variation of the radio module 100 in different scenarios, wherein the horizontal axis of the diagrams represents the time in units of second, the vertical axis of the diagrams represents the TX power of the radio module 100 in units of decibel relative to one milliwatt (dBm), the diagram 202 corresponds to the predetermined scenario SCE PRE, the diagram 204 corresponds to the scenario SCE_1, and the diagram 206 corresponds to the scenario SCE_2. For the scenario SCE_1, in response to the scenario SCE_1 being determined to be different from the predetermined scenario SCE PRE, the radio module 100 may adjust the TA parameters according to the scenario SCE_1 so that the TX power variation of the radio module 100 is increased. For the scenario SCE_2, in response to the scenario SCE_2 being determined to be different from the predetermined scenario SCE PRE, the radio module 100 may adjust the TA parameters according to the scenario SCE_2 so that the TX power variation of the radio module 100 is decreased.

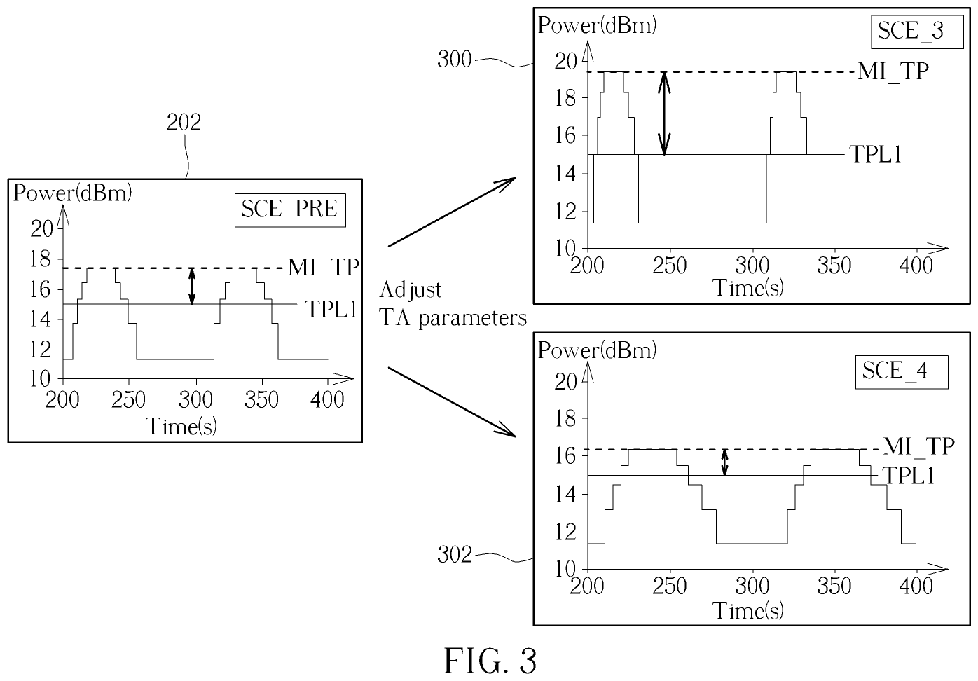

FIG. 3 is a diagram illustrating a TA parameter adjustment scheme according to a second embodiment of the present invention. As shown in FIG. 3, three diagrams 202, 300, and 302 illustrate the TX power variation of the radio module 100 in different scenarios, wherein the diagram 202 corresponds to the predetermined scenario SCE PRE, the diagram 300 corresponds to a scenario SCE_3, and the diagram 302 corresponds to a scenario SCE_4. For the scenario SCE_3, in response to the scenario SCE_3 being determined to be different from the predetermined scenario SCE PRE, the radio module 100 may adjust the TA parameters according to the scenario SCE_3 so that the maximum instantaneous TX power MI_TP of the radio module 100 is increased (i.e., a range from the TX power limit TPL1 to the maximum instantaneous TX power MI_TP is increased). For the scenario SCE_4, in response to the scenario SCE_4 being determined to be different from the predetermined scenario SCE PRE, the radio module 100 may adjust the TA parameters according to the scenario SCE_4 so that the maximum instantaneous TX power MI_TP of the radio module 100 is decreased (i.e., the range from the TX power limit TPL1 to the maximum instantaneous TX power MI_TP is decreased).

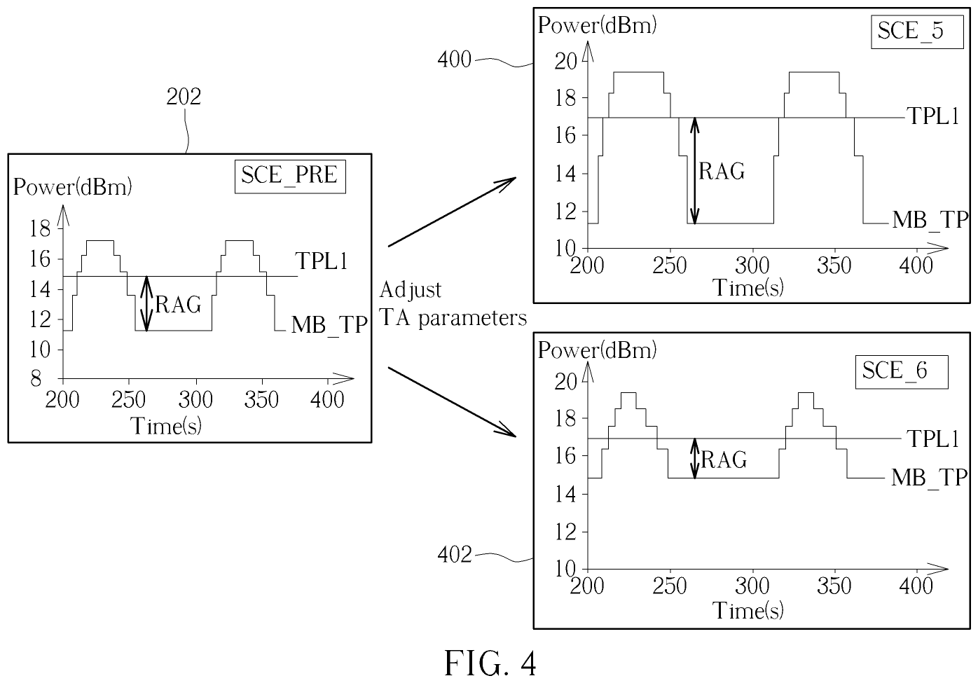

FIG. 4 is a diagram illustrating a TA parameter adjustment scheme according to a third embodiment of the present invention. As shown in FIG. 4, three diagrams 202, 400, and 402 illustrate the TX power variation of the radio module 100 in different scenarios, wherein the diagram 202 corresponds to the predetermined scenario SCE PRE, the diagram 400 corresponds to a scenario SCE 5, and the diagram 402 corresponds to a scenario SCE 6. For the scenario SCE 5, in response to the scenario SCE 5 being determined to be different from the predetermined scenario SCE PRE, the radio module 100 may adjust the TA parameters according to the scenario SCE 5 so that a range RAG of a backoff TX power (e.g., a range from the TX power limit TPL1 to the minimum backoff TX power MB_TP) of the radio module 100 is increased. For the scenario SCE 6, in response to the scenario SCE 6 being determined to be different from the predetermined scenario SCE PRE, the radio module 100 may adjust the TA parameters according to the scenario SCE 6 so that the range RAG of the backoff TX power of the radio module 100 is decreased.

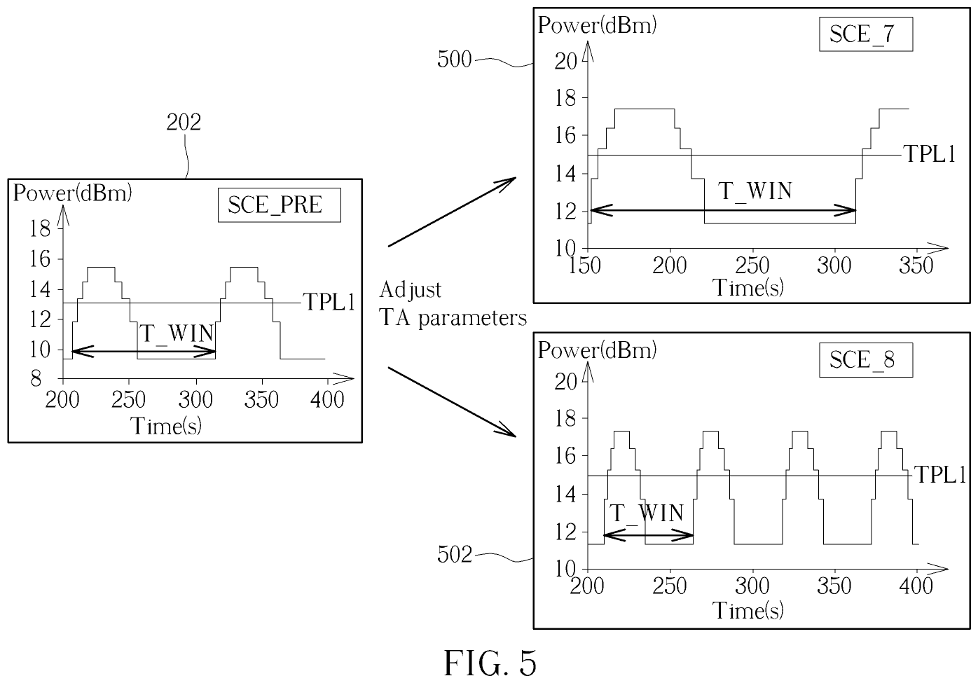

FIG. 5 is a diagram illustrating a TA parameter adjustment scheme according to a fourth embodiment of the present invention. As shown in FIG. 5, three diagrams 202, 500, and 502 illustrate the TX power variation of the radio module 100 in different scenarios, wherein the diagram 202 corresponds to the predetermined scenario SCE PRE, the diagram 500 corresponds to a scenario SCE 7, and the diagram 502 corresponds to a scenario SCE 8. For the scenario SCE 7, in response to the scenario SCE 7 being determined to be different from the predetermined scenario SCE PRE, the radio module 100 may adjust the TA parameters according to the scenario SCE 7 so that a range of a time window T WIN of the radio module 100 is increased, which makes the TX power switching slower. For the scenario SCE 8, in response to the scenario SCE 8 being determined to be different from the predetermined scenario SCE PRE, the radio module 100 may adjust the TA parameters according to the scenario SCE 8 so that the range of the time window T WIN of the radio module 100 is decreased, which makes the TX power switching faster.

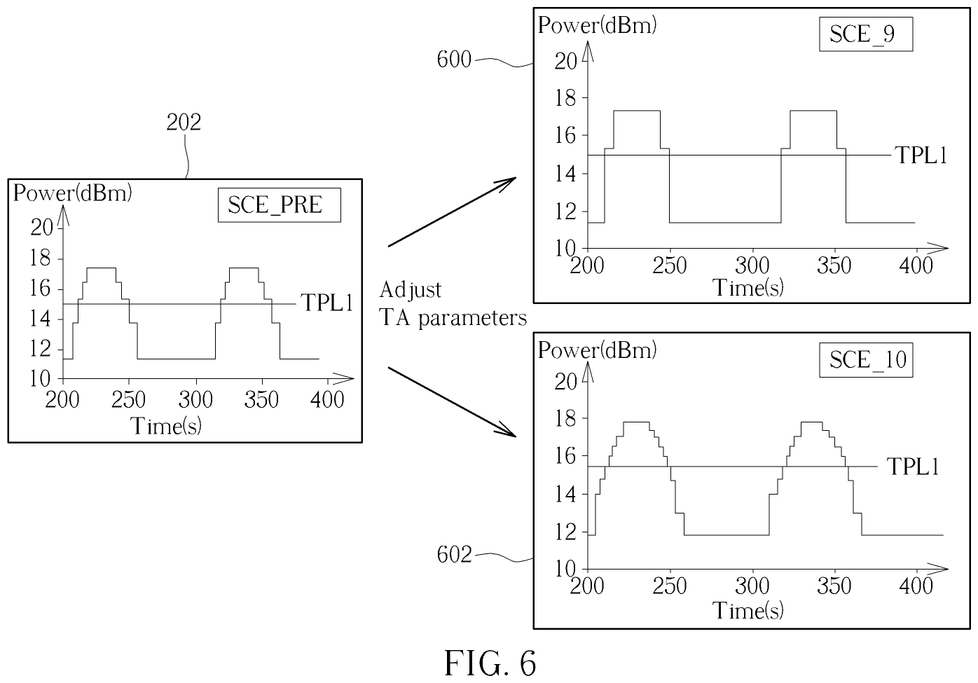

FIG. 6 is a diagram illustrating a TA parameter adjustment scheme according to a fifth embodiment of the present invention. As shown in FIG. 6, three diagrams 202, 600, and 602 illustrate the TX power variation of the radio module 100 in different scenarios, wherein the diagram 202 corresponds to the predetermined scenario SCE PRE, the diagram 600 corresponds to a scenario SCE 9, and the diagram 602 corresponds to a scenario SCE 10. For the predetermined scenario SCE PRE, a number of power levels of the TX power of the radio module 100 is predetermined to be 5. For the scenario SCE 9, in response to the scenario SCE 9 being determined to be different from the predetermined scenario SCE PRE, the radio module 100 may adjust the TA parameters according to the scenario SCE 9 so that the number of power levels of the TX power of the radio module 100 is decreased (e.g., decreased from 5 to 3), which makes the TX power variation rougher. For the scenario SCE 10, in response to the scenario SCE 10 being determined to be different from the predetermined scenario SCE PRE, the radio module 100 may adjust the TA parameters according to the scenario SCE 10 so that the number of power levels of the TX power of the radio module 100 is increased (e.g., increased from 5 to 8), which makes the TX power variation smoother.

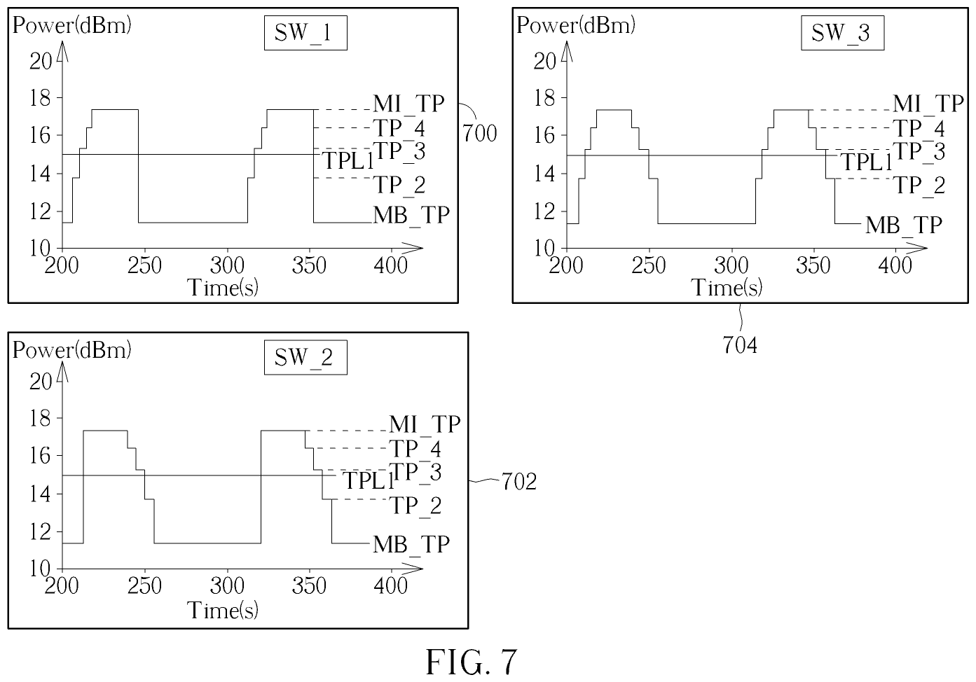

In addition to adjusting the TA parameters according to the scenario, the radio module 100 may be further arranged to determine a switching mode SW M for the power levels of the TX power of the radio module 100 according to the scenario, and control the TX power of the radio module 100 according to the switching mode SW M. For example, the radio module 100 may be arranged to control the TX power of the radio module 100 to any of the power levels. Specifically, please refer to FIG. 7. FIG. 7 is a diagram illustrating examples of the switching mode SW M for the power levels of the TX power of the radio module 100 according to an embodiment of the present invention. In this embodiment, the switching mode SWM may be switched between switching modes SW 1-SW 3 according to the scenario, but the present invention is not limited thereto. As shown in FIG. 7, three diagrams 700, 702, and 704 illustrate the switching modes SW 1-SW 3 for the power levels of the TX power of the radio module 100 in different scenarios, wherein the diagram 700 corresponds to the switching mode SW 1, the diagram. 702 corresponds to the switching mode SW 2, and the diagram 704 corresponds to the switching mode SW 3.

For the switching mode SW 1, during a process of switching from the minimum backoff TX power MB_TP to the maximum instantaneous TX power MI_TP, the TX power of the radio module 100 is controlled to be switched from the minimum power level to the maximum power level in sequence. For example, assume that a number of power levels of the TX power of the radio module 100 is 5, and the power levels from small to large are MB_TP, TP_2, TP_3, TP_4, and MI_TP. The TX power of the radio module 100 may be controlled to be switched from the minimum backoff TX power MB_TP to the power level TP_2, the power level TP_3, the power level TP_4, and the maximum instantaneous TX power MI_TP in sequence. That is, the TX power will be switched to the maximum instantaneous power MI_TP slower, and the TX power will be switched from a current power level to a next power level earlier. During a process of switching from the maximum instantaneous TX power MI_TP to the minimum backoff TX power MB_TP, the TX power of the radio module 100 is controlled to be switched from the maximum power level (i.e., the maximum instantaneous TX power MI_TP) to the minimum power level (i.e., the minimum backoff TX power MB_TP) directly. That is, the TX power will be switched to the minimum backoff TX power MB_TP faster, and the TX power will be switched from a current power level to a next power level later.

For the switching mode SW 2, during a process of switching from the minimum backoff TX power MB_TP to the maximum instantaneous TX power MI_TP, the TX power of the radio module 100 is controlled to be switched from the minimum power level (i.e., the minimum backoff TX power MB_TP) to the maximum power level (i.e., the maximum instantaneous TX power MI_TP) directly. That is, the TX power will be switched to the maximum instantaneous TX power MI_TP faster, and the TX power will be switched from a current power level to a next power level later. During a process of switching from the maximum instantaneous TX power MI_TP to the minimum backoff TX power MB_TP, the TX power of the radio module 100 is controlled to be switched from the maximum power level to the minimum power level in sequence. For example, assume that a number of power levels of the TX power of the radio module 100 is 5, and the power levels from large to small are MI_TP, TP_4, TP_3, TP_2, and MB_TP. The TX power of the radio module 100 may be controlled to be switched from the maximum instantaneous TX power MI_TP to the power level TP_4, the power level TP_3, the power level TP_2, and the minimum backoff TX power MB_TP in sequence. That is, the TX power will be switched to the minimum backoff TX power MB_TP slower, and the TX power will be switched from a current power level to a next power level earlier.

For the switching mode SW 3, during a process of switching from the minimum backoff TX power MB_TP to the maximum instantaneous TX power MI_TP, the TX power of the radio module 100 is controlled to be switched from the lower power level to the higher power level in sequence or from the lower power level to any higher power level. For example, assume that a number of power levels of the TX power of the radio module 100 is 5, and the power levels from small to large are MB_TP, TP_2, TP_3, TP_4, and MI_TP. The TX power of the radio module 100 may be controlled to be switched from the minimum backoff TX power MB_TP to the power level TP_2, the power level TP_3, the power level TP_4, and the maximum instantaneous TX power MI_TP in sequence. That is, the TX power will be switched to the maximum instantaneous power MI_TP slower, and the TX power will be switched from a current power level to a next power level earlier. During a process of switching from the maximum instantaneous TX power MI_TP to the minimum backoff TX power MB_TP, the TX power of the radio module 100 is controlled to be switched from the higher power level to the lower power level in sequence or from the higher power level to any lower power level. For example, the TX power of the radio module 100 may be controlled to be switched from the maximum instantaneous TX power MI_TP to the power level TP_4, the power level TP_3, the power level TP_2, and the minimum backoff TX power MB_TP in sequence. That is, the TX power will be switched to the minimum backoff TX power MB_TP slower, and the TX power will be switched from a current power level to a next power level earlier.

In addition, the radio module 100 may be further arranged to determine the power levels of the TX power of the radio module 100 according to the scenario. For example, the radio module 100 may determine multiple power levels (e.g., the power levels TP_2-TP_4 shown in FIG. 7) between the maximum instantaneous TX power MI_TP and the minimum backoff TX power MB_TP. Regarding each of the one or more configurations, the TX power of the radio module 100 may be normalized to generate a normalized TX power, and it is determined that which of the power levels the normalized TX power belongs to, for avoiding exceeding the TX power limit TPL1. Furthermore, in order to avoid temporal regulation violations when changing between different scenarios, a power state of the TX power of the radio module 100 may be determined according to the scenario, and the TX power of the radio module 100 is switched between the power levels according to the power state.

After determining the power levels and the power state, the radio module 100 may be further arranged to perform TX power ratio allocation operations. Specifically, the radio module 100 may include circuits arranged to receive weighting information from a user or different scenarios for allocating a TX power ratio TXR1 of the radio module 100 and a TX power ratio TXR2 of the radio module 102. For example, the weighting information may be predetermined fixed ratios for the TX power ratios TXR1 and TXR2 from the user or the different scenarios. The radio module 100 may be arranged to adjust the TX power ratios TXR1 and TXR2 according to the at least one message M1 and/or the at least one message M2 to obtain adjusted TX power ratios A TXR1 and A TXR2, respectively, and adjust the TX power limit TPL1 according to the adjusted TX power ratio A TXR1, to generate an adjusted TX power limit ATPL1 of the radio module 100.

Afterwards, the radio module 100 may control an instantaneous TX power of the radio module 100 to make an average TX power of the radio module 100 lower than or equal to the adjusted TX power limit ATPL1. After the average TX power of the radio module 100 is controlled to be lower than or equal to the adjusted TX power limit ATPL1 of the radio module 100, the radio module 100 may be further arranged to calculate the at least one message M1 of the radio module 100, for interacting with the radio module 102. For example, the radio module 100 may calculate the previous TX power ratio, the TX power ratio margin, the one or more TX performance indices, the one or more RX performance indices, the one or more weighting information, or the one or more configurations. Since the operations of TX ratio allocation are well known to those with ordinary knowledge in the art, and the focus of the present invention is on the scenario-based TA parameters adjustment, further descriptions are omitted here for brevity.

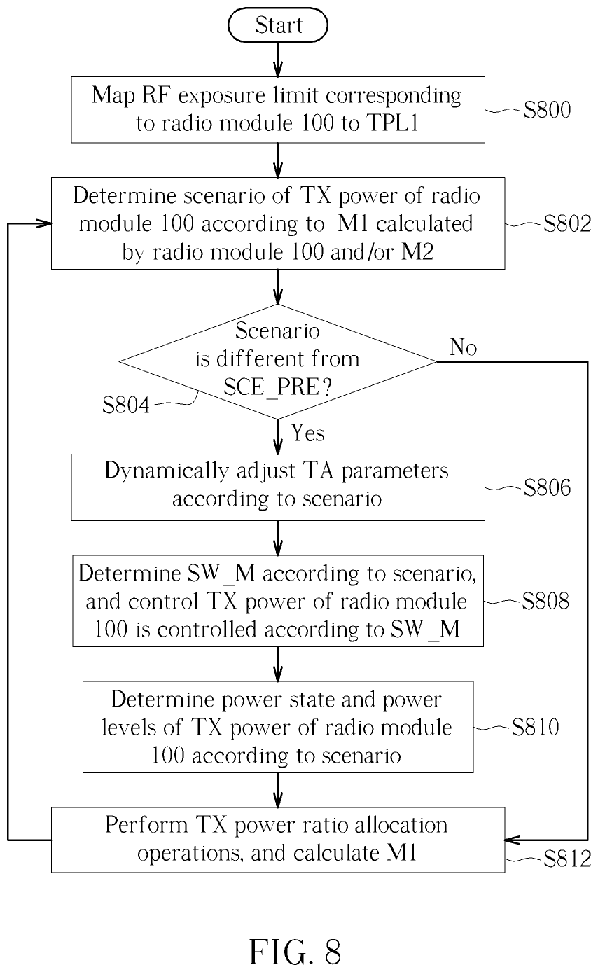

FIG. 8 is a diagram illustrating a flow chart of a method for adjusting TA parameters of a TX power of a radio module according to an embodiment of the present invention. Provided that the result is substantially the same, the steps are not required to be executed in the exact order shown in FIG. 8. For example, the method shown in FIG. 8 may be employed by the radio module 100 shown in FIG. 1.

In Step S800, the RF exposure limit corresponding to the radio module 100 is mapped to the TX power limit TPL1.

In Step S802, the at least one message M2 of the radio module 102 is obtained by interacting with the radio module 102, and the scenario of the TX power of the radio module 100 is determined according to the at least one message M1 calculated by the radio module M1 and/or the at least one message M2.

In Step S804, it is determined whether the determined scenario is different from the predetermined scenario SCE PRE. If yes (e.g., the determined scenario is different from the predetermined scenario SCE PRE), Step S806 is entered; if no (e.g., the determined scenario is the same as the predetermined scenario SCE PRE), Step S812 is entered.

In Step S806, the TA parameters may be dynamically adjusted according to the determined scenario. For example, the TX power variation, the maximum instantaneous TX power MI_TP, the range RAG of the backoff TX power, the range of the time window T WIN, and the number of power levels of the TX power of the radio module 100 can be increased/decreased by adjusting the TA parameters.

In Step S808, the switching mode SW M for the power levels of the TX power of the radio module 100 is determined according to the determined scenario, and the TX power of the radio module 100 is controlled according to the switching mode SW M.

In Step S810, the power state and the power levels of the TX power of the radio module 100 are determined according to the determined scenario.

In Step S812, the TX power ratio allocation operations are performed, and the at least one message M1 is calculated.

Since a person skilled in the pertinent art can readily understand details of the steps after reading above paragraphs directed to the radio module 100 shown in FIG. 1, further descriptions are omitted here for brevity.

In summary, by the method and the associated radio module of the present invention, under a condition that different TX power adjustment of a radio module are required for different scenarios, a scenario of a TX power of the radio module can be determined according to the at least one message of the radio module and/or at least one message of at least one other radio module, and the TA parameters for TX power variation of the radio module can be dynamically adjusted according to the determined scenario, which can improve data throughput and network capacity efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting time-averaged (TA) parameters of a transmitting (TX) power of a radio module, comprising:
obtaining at least one message of the at least one other radio module or at least one message of the radio module;
determining a scenario of the TX power of the radio module according to the at least one message of the at least one other radio module or the at least one message of the radio module;
determining whether the scenario is different from a predetermined scenario of the TX power of the radio module; and
in response to the scenario being different from the predetermined scenario, adjusting the TA parameters according to the scenario.

2. The method of claim 1, wherein the step of in response to the scenario being different from the predetermined scenario, adjusting the TA parameters according to the scenario comprises:
adjusting the TA parameters to increase or decrease a TX power variation of the radio module.

3. The method of claim 1, wherein the step of in response to the scenario being different from the predetermined scenario, adjusting the TA parameters according to the scenario comprises:
adjusting the TA parameters to increase or decrease a maximum instantaneous TX power of the radio module.

4. The method of claim 1, wherein the step of in response to the scenario being different from the predetermined scenario, adjusting the TA parameters according to the scenario comprises:
adjusting the TA parameters to increase or decrease a range of a backoff TX power of the radio module.

5. The method of claim 1, wherein the step of in response to the scenario being different from the predetermined scenario, adjusting the TA parameters according to the scenario comprises:
adjusting the TA parameters to increase or decrease a range of a time window of the TX power of the radio module.

6. The method of claim 1, wherein the step of in response to the scenario being different from the predetermined scenario, adjusting the TA parameters according to the scenario comprises:
adjusting the TA parameters to increase or decrease a number of power levels of the TX power of the radio module.

7. The method of claim 1, further comprising:
determining a switching mode of multiple power levels of the TX power of the radio module according to the scenario; and
controlling the TX power of the radio module according to the switching mode.

8. The method of claim 7, wherein the step of controlling the TX power of the radio module according to the switching mode comprises:
during a process of switching from a minimum backoff TX power to a maximum instantaneous TX power, controlling the TX power of the radio module to switch from a minimum power level to a maximum power level in sequence; and
during a process of switching from the maximum instantaneous TX power to the minimum backoff TX power, controlling the TX power of the radio module to switch from the maximum power level to the minimum power level directly.

9. The method of claim 7, wherein the step of controlling the TX power of the radio module according to the switching mode comprises:
during a process of switching from a minimum backoff TX power to a maximum instantaneous TX power, controlling the TX power of the radio module to switch from a minimum power level to a maximum power level directly; and
during a process of switching from the maximum instantaneous TX power to the minimum backoff TX power, controlling the TX power of the radio module is switched from the maximum power level to the minimum power level in sequence.

10. The method of claim 7, wherein the step of controlling the TX power of the radio module according to the switching mode comprises:
during a process of switching from a minimum backoff TX power to a maximum instantaneous TX power, controlling the TX power of the radio module to switch from a minimum power level to a maximum power level in sequence; and
during a process of switching from the maximum instantaneous TX power to the minimum backoff TX power, controlling the TX power of the radio module to switch from the maximum power level to the minimum power level in sequence.

11. The method of claim 7, wherein the step of controlling the TX power of the radio module according to the switching mode comprises:
controlling the TX power of the radio module to any of the multiple power levels.

12. The method of claim 1, further comprising:
determining multiple power levels and a power state of the TX power of the radio module according to the scenario.

13. A radio module for adjusting time-averaged (TA) parameters of a transmitting (TX) power of the radio module, wherein the radio module is arranged to:
obtain at least one message of at least one other radio module or at least one message of the radio module;
determine a scenario of the TX power of the radio module according to the at least one message of the at least one other radio module or the at least one message of the radio module;
determine whether the scenario is different from a predetermined scenario of the TX power of the radio module; and
in response to the scenario being different from the predetermined scenario, adjust the TA parameters according to the scenario.

14. The radio module of claim 13, wherein the radio module is arranged to adjust the TA parameters to increase or decrease a TX power variation of the radio module.

15. The radio module of claim 13, wherein the radio module is arranged to adjust the TA parameters to increase or decrease a maximum instantaneous TX power of the radio module.

16. The radio module of claim 13, wherein the radio module is arranged to adjust the TA parameters to increase or decrease a range of a backoff TX power of the radio module.

17. The radio module of claim 13, wherein the radio module is arranged to adjust the TA parameters to increase or decrease a range of a time window of the TX power of the radio module.

18. The radio module of claim 13, wherein the radio module is arranged to adjust the TA parameters to increase or decrease a number of power levels of the TX power of the radio module.

19. The radio module of claim 13, wherein the radio module is further arranged to determine a switching mode of multiple power levels of the TX power of the radio module according to the scenario, and control the TX power of the radio module according to the switching mode.

20. The radio module of claim 19, wherein during a process of switching from a minimum backoff TX power to a maximum instantaneous TX power, the TX power of the radio module is switched from a minimum power level to a maximum power level in sequence, and during a process of switching from the maximum instantaneous TX power to the minimum backoff TX power, the TX power of the radio module is switched from the maximum power level to the minimum power level directly.

21. The radio module of claim 19, wherein during a process of switching from a minimum backoff TX power to a maximum instantaneous TX power, the TX power of the radio module is switched from a minimum power level to a maximum power level directly, and during a process of switching from the maximum instantaneous TX power to the minimum backoff TX power, the TX power of the radio module is switched from the maximum power level to the minimum power level in sequence.

22. The radio module of claim 19, wherein during a process of switching from a minimum backoff TX power to a maximum instantaneous TX power, the TX power of the radio module is switched from a minimum power level to a maximum power level in sequence, and during a process of switching from the maximum instantaneous TX power to the minimum backoff TX power, the TX power of the radio module is switched from the maximum power level to the minimum power level in sequence.

23. The radio module of claim 19, wherein the radio module is further arranged to control the TX power of the radio module to any of the multiple power levels.

24. The radio module of claim 13, wherein the radio module is further arranged to determine multiple power levels and a power state of the TX power of the radio module according to the scenario.
